(19) United States
(12) Patent Application Publication
(10) Pub. No.: US 2026/0052094 A1
(43) Pub. Date: Feb. 19, 2026

(54) INTERMITTENT FAILURE HANDLING FOR NETWORK FUNCTIONS

(71) Applicant: Oracle International Corporation, Redwood City, CA (US)

(72) Inventors: Rajiv Krishan, Cary, NC (US); Rishikesh Pawar, Bengaluru (IN)

(21) Appl. No.: 18/805,086

(22) Filed: Aug. 14, 2024

(51) Int. Cl. H04L 45/00; H04L 41/12

(52) U.S. Cl. CPC H04L 45/22; H04L 41/12

(57) ABSTRACT

Various embodiments herein relate to systems, methods, and computer-readable storage media for implementing intermittent failure handing for network functions. In an embodiment, a method may comprise operating a Network Function (NF) of a network, including receiving, at an alternate NF, a rerouted request originally directed to a target NF in a messaging session between NFs, the rerouted request including an indication of a reason the rerouted request was rerouted. The method may include determining, at the alternate NF based on the reason, whether to take over the messaging session from the target NF, and processing the rerouted request based on the determination.

### TECHNICAL FIELD

Various embodiments of the present technology generally relate to management of networks, such as fourth generation (4G) and fifth generation (5G) communications networks. More specifically, embodiments of the present technology relate to systems and methods for improved handling of intermittent connection failures between network functions (NFs) within networks.

### BACKGROUND

In some communication network architectures, such as those using third generation partnership project (3GPP) standards, infrastructure components may be referred to as network functions (NFs), which may each serve a purpose in providing communication service, and which may interact with each other to fulfill those purposes. From a network perspective, a consumer may be an NF that requests a service from a producer NF, and those roles may remain consistent for a session, regardless of which NF is sending a request to the other at any given time. Service may be implemented via resources which consumer NFs can create, update or delete at producer NFs through REST (representational state transfer) or Diameter interfaces. Such resources may be referred to as "context" or "session" or "binding" in a core network. For example, for some NFs such as policy control functions (PCFs), such context management can be referred to as session management, while for other NFs such as binding support functions (BSFs), context management can be referred to as binding management. In an example embodiment, a session management function (SMF) NF may create a session management (SM) session with a PCF, in order to control policies for a PDU (packet data unit or protocol data unit) session over an N7 interface, as defined by 3GPP. As used herein, the resources established between NFs may be referred to as “sessions.”

Sessions or interfaces may be established between many kinds of NFs across the network. Example sessions may include Rx interface messaging sessions (using Diameter protocol) and N7 interface messaging sessions (using service-based interface (SBI) protocol). The various sessions may establish what network components are managing network resources, quality of service, and other aspects of a user’s communication service. For example, a PDU session may be a logical connection to carry user data and support services like voice, video, and data. When a PDU session is initiated, an N7 interface may be used between SMF and PCF to manage that PDU session. The N7 interface protocol may be used to send HTTP (hypertext transfer protocol) messages within a 5G network to establish the PDU session for a user equipment (UE) between the SMF and the PCF. Similarly, an Rx interface protocol may be used to send Diameter protocol messages for allocating and managing data resources for a user session.

In some network architectures, certain NFs may be configured as part of a set of NFs serving the same function, sometimes called an NFset. The NFs within a set may exchange replicated context information for sessions in which they are participating, allowing another NF from the set to take over the session, permanently or temporarily, if the original NF fails or becomes unavailable.

NFs may initially attempt to establish sessions with other NFs situated locally to themselves, such as via a local area network (LAN). Local connections may reduce message latency and provide the fastest and most reliable messaging. If an NF participating in a session becomes unavailable (e.g., due to the NF crashing, or connectivity loss between particular NFs), the mated NF may attempt to redirect the session messaging to another NF in an NFset with the unavailable NF. However, there may be performance disadvantages to changing a session to another NF from an NFset. For example, the backup NF may not be located on a same LAN (e.g., at a same geographic location) as the other components involved in session(s) with the unavailable NF, and therefore communications with the backup NF may be over a wide area network (WAN) and experience higher latency than a LAN connection. Further, the backup NF may need to notify other NFs regarding taking over the session, such as to update user data repository (UDR) or charging function (CHF) subscriptions to consolidate notification processing at the backup NF. The longer processing latency and additional signaling changes across various NFs due to intermittent failures between NFs can lead to degradation of service in the network. Accordingly, there exists a need for improved handling of intermittent failures between network functions.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for implementing intermittent failure handling for network functions. In an embodiment, a Network Function (NF) system in a network may comprise one or more processors, and a memory having instructions stored thereon. The instructions, upon execution, may cause the one or more processors to receive, at an alternate NF, a rerouted request originally directed to a target NF in a messaging session between NFs, the rerouted request including an indication of a reason the rerouted request was rerouted. The NF system may determine, at the alternate NF based on the reason, whether to take over the messaging session from the target NF, and process the rerouted request based on the determination.

In some embodiments, the rerouted request utilizes a Diameter protocol. In some examples, the network includes a fifth generation (5G) cellular network. The messaging session may include an Rx interface protocol session, and the rerouted request includes an Rx message routed by a binding support function (BSF) to the alternate NF. In some embodiments, the NF system may determine, at the alternate NF based on the reason, whether to take over both the messaging session and a second messaging session between NFs. The second messaging session may include a Gx interface messaging session, using the Diameter protocol, between policy and charging enforcement function (PCEF) and the target NF, and the target NF and the alternate NF each include a policy and charging rules function (PCRF) instance. In another example, the second messaging session includes an N7 interface messaging session, using a service-based interface (SBI) protocol, between a session management function (SMF) and the target NF, and the target NF and the alternate NF each include a policy control function (PCF) instance, wherein the target NF and the alternate NF are both members of an NF set of NFs configured to replicate context data between the members and operate as alternates if an NF from the NF set fails. The NF system may determine that the reason is that the target NF is congested, indicating that the target NF is overloaded with traffic, and based on the reason, take over the messaging session by generating a response to the rerouted request identifying an origin-host as the alternate NF, and take over the second messaging session by performing a session management (SM) UpdateNotify operation including an updated binding header identifying the alternate NF. The NF system may determine that the reason is that the target NF is unreachable, indicating that a communication connection could not be established with the target NF, and based on the reason, determine a health status of the target NF, with an unhealthy health status indicating that the target NF is unavailable, and a healthy health status indicating that the target NF is available. Based on the target NF having a healthy health status, the NF system may determine to not take over the messaging session, including generating a response to the rerouted request identifying an origin-host as the target NF, and not take over the second messaging session, including performing a session management (SM) UpdateNotify operation without an updated binding header. Based on the target NF having an unhealthy health status, the NF system may determine to take over the messaging session by generating a response to the rerouted request identifying the origin-host as the alternate NF, and take over the second messaging session by performing a session management (SM) UpdateNotify operation including an updated binding header identifying the alternate NF.

In an alternative embodiment, a method may comprise operating a Network Function (NF) of a network, including receiving, at an alternate NF, a rerouted request originally directed to a target NF in a messaging session between NFs, the rerouted request including an indication of a reason the rerouted request was rerouted. The method may include determining, at the alternate NF based on the reason, whether to take over the messaging session from the target NF, and processing the rerouted request based on the determination.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement intermittent failure handling for network functions, in accordance with certain embodiments of the present disclosure;

FIG. 2 is a diagram of a system configured to implement intermittent failure handling for network functions, in accordance with certain embodiments of the present disclosure;

FIG. 3 depicts a flow diagram of an example method to implement intermittent failure handling for network functions, in accordance with certain embodiments of the present disclosure;

FIG. 4 depicts a flow diagram of an example method to implement intermittent failure handling for network functions, in accordance with certain embodiments of the present disclosure;

FIG. 5 depicts a flowchart of an example method to implement intermittent failure handling for network functions, in accordance with certain embodiments of the present disclosure; and

FIG. 6 is a diagram of a system configured to implement intermittent failure handling for network functions, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

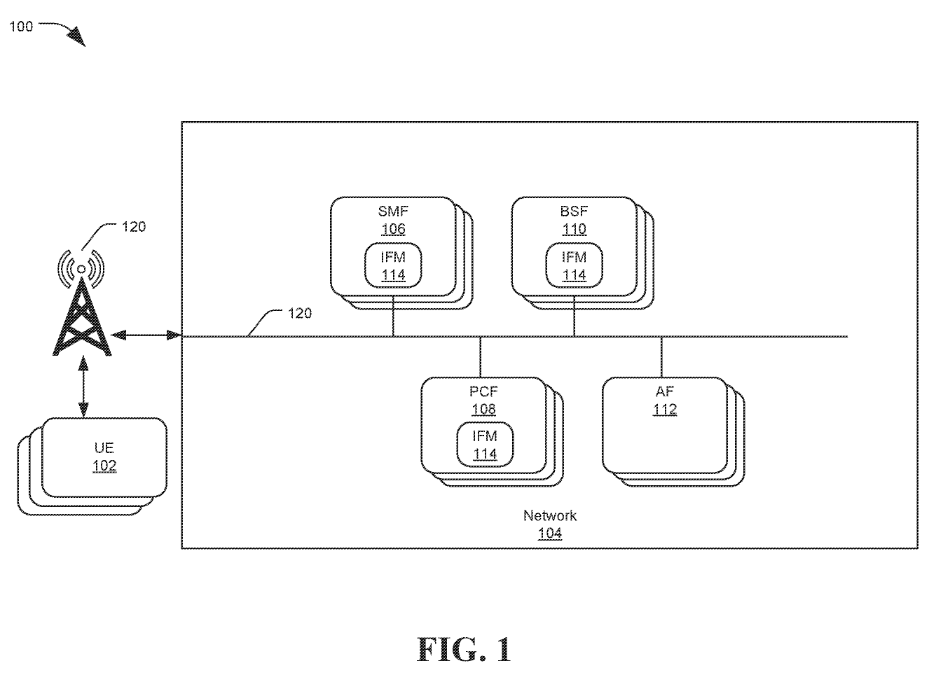

FIG. 1 is a diagram of a system 100 configured to implement intermittent failure handling for network functions, in accordance with certain embodiments of the present disclosure. The example system 100 may include a network (such as a wireless or cellular network) implementing 3GPP (3rd Generation Partnership Project) communication standards (e.g., using the 29.600 Technical Specification (TS)), although the present disclosure may apply to other communication networks. In particular, the network may include components and elements to implement a network 104, such as a 5G Core (5GC or 5GS) network, a 4G network, or a network having components and functionality from both 4G and 5G systems. The system 100 may include one or more user equipment (UE) 102 connected to network 104 via network connectivity components 120.

Each or any of UE 102, network 104 and its components, and network 120 may be implemented via computers, servers, hardware and software modules, or other system components. The components of network 104, or the physical devices implementing them, may be co-located, remotely distributed, or any combination thereof. The elements of system 100 may include components hosted or situated in the cloud, implemented as software modules potentially distributed across one or more server devices or other physical components, or otherwise implemented.

UE 102 may be a device, system, or module that may utilize the resources of the network 104, such as to establish communications with another UE. Communication sessions may include, but are not limited to, IMS calls (Internet Protocol Multimedia subsystem), other cell phone calls, internet or other data connections, UE registrations (as PCF 108 may register UE 102 bindings at the BSF 110 as part of this communication; see, e.g., 3GPP TS 29.513 5.1.1, 29.513 5.6.1, 23.602 4.16.1/.2/.11/.12), or any and all other types of communications sessions over networks. UE 102 may include devices such as cell phones, mobile devices, tablets, modems, vehicles, desktop or laptop computers, televisions or set-top boxes, smart home devices, voice over IP (VoIP) devices, internet of things (IoT) devices, or any and all other systems that may utilize a cellular or other communication network.

Network connectivity components 120 may provide communication paths between UE 102 and network 104, and between network functions (NFs) within network 104. Network connectivity components 120 may comprise components that enable communication over communication links, such as network cards, ports, radio frequency (RF) modules, telecommunications channels, cell towers, switches, routers, processing circuitry and software, or other communication components. Network connectivity components 120 may include metallic, wireless, cellular, or optical links, using various communication formats and protocols. In some examples, network connectivity components 120 may simply be referred to as a “network” by which systems or modules are connected or communicate.

Network 104 may comprise a wireless or cellular communications network that provides services to UEs 102 through the network connectivity components 120. Network 104 may include a plurality of components, modules, or NFs configured to provide communication services via the corresponding 4G or 5G communications protocols. Some components of network 104 may be configured to communicate and operate with other networks or protocols, such 5G components communicating with 4G networks or components, networks controlled by other network operators, or other network environments. Network 104 may include a session management function (SMF) 106, a policy control function (PCF) 108, a binding support function (BSF) 110, and an application function (AF) 112. There may be multiple instances of some or all of the NFs within the network 104, include NFs that are part of NF sets. For example, SMF 106 may be part of an SMFset, PCF 108 may be part of a PCFset, and BSF 110 may be part of a BSFset.

Network 104 may include an SMF 106 (or access and mobility management function (AMF), or both), configured to handle subscriber session (such as PDU or UE sessions) establishment, modification, and release. When a UE 102 connects to the network 104, an SMF or AMF 106 may initiate the PDU session creation. An SMF may include various functionality relating to subscriber sessions, e.g., session establishment, modification, and release. An AMFs primary tasks may include registration management, connection management, reachability management, mobility management, and various function relating to security and access management and authorization. Within a 5G network 104, SMF may establish an N7 session with PCF 108, while an AMF may establish an N15 session with a PCF 108 for access management. Not show may be a PCEF (policy and charging enforcement function) located at a PGW (packet data network gateway) establishing a Gx session with a PCRF (policy and charging rules function, not shown) in a 4G network.

PCF 108 may be assigned to a subscriber session (e.g., a PDU or UE session) created when a UE 102 registers with the network 104. The PCF 108 may generate policy rules for the session to control quality of service and charging for the session, and may register the subscriber session with the BSF 110.

BSF 110 may maintain a list, database, or other data structure of binding records describing which PCF 108 is assigned to a subscriber session, or which PCF 108 is assigned to a subscriber registration related association. The BSF 110 may provide the binding support management service (Nbsf_Management service), allowing the BSF to provide subscriber session binding functionality, which can ensure that an AF 112 request for a certain session can reach the relevant PCF 108 having the session information. The BSF 110 may create a binding record when a PCF 108 registers a session with BSF 110, and this binding for the PCF 108 may be referred to as a binding session. An AF 112 seeking to discover the session binding for a UE 102 may do so by querying the BSF 110 using a discovery application programming interface (API) provided by the BSF.

The AF 112 may provide application services to consumers and UEs 102, and perform traffic routing for applications. The AF 112 may interact with the PCF 108 to enable policy control for the application services. An AF 112 may query the BSF 110 to determine a PCF 108 managing a subscriber session, and messaging from an AF 112 to a PCF 108 may be routed through the BSF 110 in some instances. AF 112 may utilize Rx protocol sessions to manage the applications services.

A consumer NF may initiate a session with a producer NF, such as a PCF 108 establishing a binding session with BSF 110. However, there may be intermittent failures between NFs, which can cause alternate routing to another NF in a set, which may result in additional latency, additional messaging and processing between NFs, and other issues. For example, if an AF 112 attempts to route an Rx message through BSF 110 to PCF 108, and BSF 110 cannot reach the PCF 108 associated with the subscriber session, the BSF 110 may need to re-route the Rx message to a backup PCF in the PCFset. The backup PCF may need to be messaged via WAN instead of LAN, resulting in higher messaging latency. Without knowing the cause of the intermittent failure, the backup PCF may need to take over for the primary PCF 108 for sessions with other NFs as well, such as SMF 106, or may need to update various subscriptions with other NFs. This can cause unnecessary messaging within network 104.

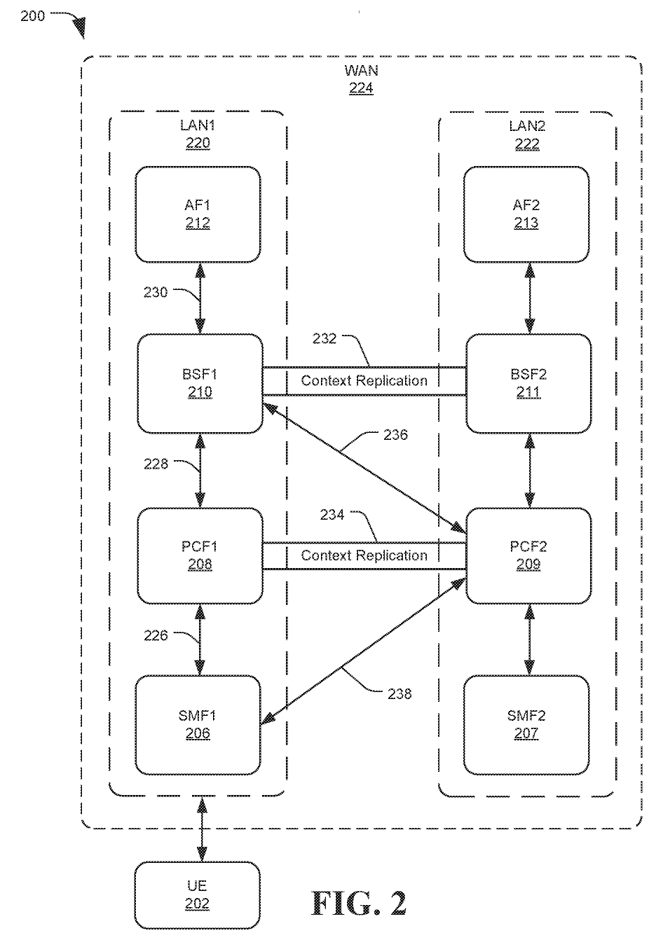

Accordingly, NFs within network 104, such as SMF/AMF 106, BSF 110, and PCF 108 may include an intermittent failure module (IFM) 116 to more gracefully manage intermittent failures, and minimize the performance impact on the network 104. The IFM 114 may include a module configured to determine a cause or type of the intermittent failure, and based on that information, determine how to handle failure to minimize impacts on the network 104. For example, a backup PCF 108, via IFM 114, may determine whether to permanently take over for an original PCF, or whether to simply handle the current rerouted message while keeping the original PCF as the primary PCF for the session. An example system for managing intermittent failures is shown in FIG. 2.

FIG. 2 depicts an example diagram of a system 200 configured to implement intermittent failure handling for network functions, in accordance with certain embodiments of the present disclosure. In particular, system 200 may be a representation of communications and sessions established between various NFs within a network, and how backup or second NFs from an NFset may take over when an original NF in a session experiences a failure. The system 200 may include a UE 202 and a plurality of NFs, some of which may be part of a same NFset and configured to take over for mated NF in case of a failure. The NFs of system 200 may include SMF1206, SMF2207, PCF1208, PCF2209, BSF1210, BSF2211, AF1212, and AF2213, which may correspond to SMF 206, PCF 108, BSF 110, and AF 112 of FIG. 1.

System 200 may include multiple network infrastructure components included within a wide area network (WAN) 224, which components may be grouped within local networks, such as local area network 1 (LAN1) 220 and LAN2222. LAN1220 may include SMF1206, PCF1208, BSF1210, and AF1212, while LAN2222 may include SMF2207, PCF2209, BSF2211, and AF2 213. Components connected by a LAN may have faster communication rates and lower latency than components that are only connected over WAN 224.

In an example situation, a user equipment (UE) 202 may connect to the network. Based on the location of the UE 202 or other factors, the connection may be made with components of LAN1220. Initiating the connection may cause session management function 1 (SMF1) 206 to establish an N7 session 226 with policy control function 1 (PCF1) 208. In turn, the PCF1208 may create a binding record or session 228 with binding support function 1 (BSF1) 210. The binding record allows AFs to determine a PCF managing a UE connection. Accordingly, application function 1 (AF1) 212 may trigger an Rx protocol session 230 through BSF1210. The BSF1210 may lookup the binding information and route the Rx messaging to the appropriate PCF1208. Based on operator policies, the context of the Rx messaging, or other details, the PCF1208 may trigger an update with SMF1206 via session 226 to update policies or rules for the UE connection.

NFs that are part of an NFset may perform context replication with each other, so that one or more other NFs in the set have the information required to take over a session if the original NF fails. For example, BSF1210 and BSF2211 may be part of a BSF set, and accordingly they may perform context replication 232 with each other, for example to exchange binding records created at each. Similarly, PCF1208 and PCF2209 may perform context replication 234, for information on UE connections that each is handling policy details for, information on sessions 226, 228, or 230 that the PCF may be involved in, or other context details. Although two instances of an NF are shown here for each set (e.g., PCF1 208 and PCF2209), any number of NF instances may be included in a set.

In case of NF instance failure, where one or more NF components may fail or otherwise become unavailable, an alternate NF instance may be selected for routing (e.g., based on binding information for service-based interface (SBI) or Diameter configuration at BSF1210 or AF1212). An example embodiment may be described herein where a failure occurs between BSF1210 and PCF1208, although the described problems and proposed solutions may be applicable to failures between other NFs. BSF1210 may receive an Rx message from AF1212 for routing to PCF1 208. However, BSF1210 may be unable to reach PCF1208, due to a variety of reasons. The connection failure may be an intermittent failure that may resolve itself soon, or it may be a prolonged failure. In either event, when BSF1210 experiences a failure with PCF1208 over connection 228, BSF1 210 may attempt to route the Rx message to an alternate PCF from a same PCFset as PCF1208. The PCFs included in a PCFset may be identified to BSF1210 when PCF1208 creates a binding record with BSF1210. Accordingly, BSF1210 may identify PCF2209 as a backup PCF in the PCFset, and send the Rx communication to PCF2 over connection 236. When PCF2209 processes the Rx request 236 and generates a response, it may provide its own identity in the Origin-Host field of the response, rather than the identity of PCF1208. Accordingly, subsequent Rx flow for that session may be directed to the alternate PCF instance of PCF2209.

Further, when PCF2209 handles the Rx flow, it may trigger a session management (SM) update notify operation 238 to the SMF handling the UE 202 connection; in this case, SMF1206. For example, PCF2209 may choose to provide updated binding header information to SMF1206, directing SMF1 to redirect subsequent N7 routing to the new PCF instance at PCF2209, for example via connection 238. If an updated binding header directing future N7 traffic to PCF2209 is not provided to SMF1206, then N7 traffic for the UE connection may still be provided to PCF1208, even though Rx traffic is being routed to PCF2209. When N7 and Rx flows are being handled at different sites, there may be a lag between context data updates 234 between sites. It can complicate evaluating correct policies at SMF1 206 in real-time. Thus, in PCF deployment operators may prefer to converge N7 and Rx routing to a same PCF instance.

Communications to alternate PCF instances may have higher WAN latency than communications with a local PCF instance (e.g., within a same LAN). Accordingly, if the Rx 236 and N7 session 238 are relocated to PCF2209, then BSF1210 to PCF2 and SMF1 206 to PCF2 may be over WAN and encounter longer processing delays . Also, consolidating to PCF2 209 may require PCF2 to update UDR (user data repository) or CHF (charging function) subscriptions to consolidate notifications processing at PCF2. Along with the additional processing latency, the updates may cause many signaling changes across various NFs when handling intermittent failures between PCF and BSF. Accordingly, solutions are proposed herein to absorb intermittent failures gracefully, in order to minimize the impact on signaling flow.

Improving intermittent failure handling may involve understanding different types or causes of failures between BSF1 210 and PCF1208, and making those causes more transparent to PCF2209. BSF1210 may select PCF2209 as an alternate for Rx flows intended for PCF1, according to the binding session record 228, based on any of the following reasons:

1. Intermittent failures: PCF1208 connectivity has intermittent failures with BSF1210 due to network loss, higher packet drops, or higher latency. Once the issue is resolved, the preference may be to keep routing at PCF1, rather than to continue routing to PCF2.

2. Congested: PCF1208 may be congested and therefore rejected the Rx session requests for lower priority requests. A congested NF may be overloaded with traffic, such as from processing too many other sessions or requests to accept additional requests. In this case, the PCF2 209 may be expected to take over Rx and N7 session context, rather than continuing attempting routing to PCF1 208.

3. Permanent failure: PCF1208 may have a permanent failure, such as due to PCF1 crashing. In this case PCF2209 may be expected to take over Rx and N7 session context for PCF1208.

Thus, PCF2 209 may benefit from knowledge of what triggered the alternate routing from BSF1210. Further, PCF2209 may also benefit from health status information regarding PCF1208. The health status of a mated NF instance can be determined through an NRF (network or NF repository function) subscription, or any proprietary interface between PCF instances of the same set. Currently there may be no such alternate routing information in Rx messaging that would allow an alternate PCF to determine the cause of alternate routing and help minimize the impact of relocating an N7 session when taking over an Rx session.

Accordingly, a vendor specific AVP (attribute value pair), such as “ReRoute cause”, may be injected by BSF1210 (or a Diameter routing agent (DRA) situated between BSF1210 and PCF2209) upon performing alternate routing to PCF2 for an Rx session. An AVP may be a term given to an information element of Diameter protocol messages. Each Diameter message may contain several different AVPs, such as a Destination-Host AVP, a Server-Name AVP, a Subscription ID AVP, a Framed IP Address AVP, etc., and custom or vendor-specific AVPs can also be added. The ReRoute cause AVP may have a number of possible values, such as:

1. “unreachable”: may be set when BSF1 210 performs alternate routing due to connectivity failure with target PCF1 208 instance. In terms of transmission control protocol (TCP) connectivity for sending messages, the “unreachable” result may occur when BSF1 210 sends a synchronization (SYN) message to PCF1 208 as part of a connection setup handshake, but the SYN message is never received and acknowledged, and so the connection setup fails.

2. “timeout”: may be set when BSF1 210 performs alternate routing due to a request timeout with target PCF1 208 instance. In terms of TCP connectivity, “timeout” may occur when the connection setup handshake has been completed and the Rx request is transmitted, but no response is received.

3. “congested”: may be set when BSF1 210 performs alternate routing due to PCF1 208 rejecting the Rx request due to congestion or overload.

Additional, fewer, or different AVP values or labels may also be used. For example, an entire word (e.g., ‘unreachable’, etc.) may be sent as the value, or some flag may be sent, or another code value may be used in place of the word values.

When the “ReRoute-cause” AVP is set to “unreachable”, PCF2 209 may determine a health status of PCF1208 (e.g., through NRF profile check or custom direct health check between PCF instances). If PCF1208 is healthy, then PCF2209 may process the Rx request and generate an answer or response with the origin-host set to PCF1, so that future Rx messaging will continue to be routed to PCF1. If required, PCF2209 may trigger an SM update notification (on N7 238) without any update to the binding header, so that the N7 session remains with PCF1 208. If PCF1208 continues to have network failure on subsequent Rx requests, BSF1210 may continue to perform alternate routing with custom header AVPs to PCF2209. A network operator can either correct the network problem or shutdown PCF1208 for recovery, in some examples. In another example, PCF2309 or another component of system 300 may maintain an “error count” for Rx messages rerouted from PCF1308, and may be configured to permanently take over after a threshold number of redirects occur consecutively or within a specified time period. If the AVP is set to “unreachable” and PCF1208 is unhealthy, then PCF2209 may process the Rx request and generate a response with the origin-host set to PCF2. If required, PCF2209 may trigger an SM update notification with an updated binding header, so that future N7 communications are directed to PCF2.

When the “ReRoute-cause” AVP is set to “congested”, or this AVP is missing, PCF2209 may process the Rx request and generate a response with the origin-host set to PCF2. The response may be passed all the way back to the AF 212 (or P-CSCF, Proxy Call Session Control Function, not shown), so that subsequent requests on the same Rx session may be sent to the alternate PCF2 209. PCF2209 may also send a binding update request to cause the binding record for the PDU session to be updated at BSF1210 so future Rx sessions for the PDU 202 session are routed to PCF2 209. In some embodiments, a BSF1210 may update the binding record in its database based on the updated origin-host value alone, although it may not be recommended for producers to update context information without a specific request from the consumer. If required, PCF2 209 may trigger an SM update notify message (on N7) with an updated binding header, so that the N7 session is consolidated to PCF2.

When the “ReRoute-cause” AVP is set to “timeout”, the PCF2209 may operate in various ways based on the operator configuration, such as handling the AVP as if it were “unreachable” or “congested” as above.

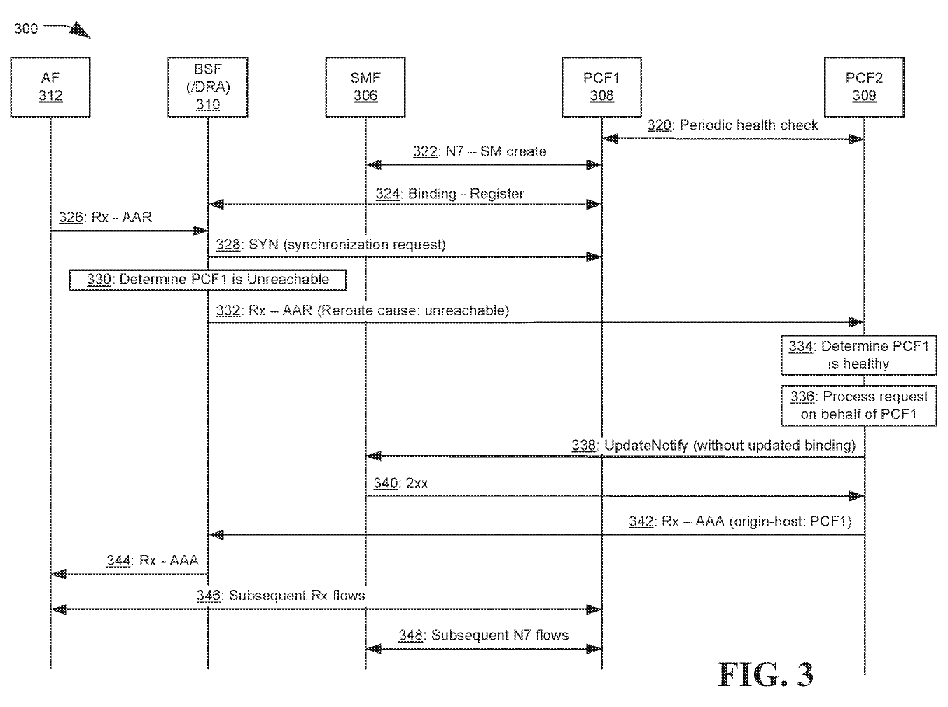

According to the proposed implementation, a PCF may monitor the health of its mate instances and, based on BSF routing information, may determine to either process an Rx request on behalf of the original PCF instance, or take over the Rx and N7 contexts ownership. The proposal enables graceful handling of intermittent failures (like network/timeout issues), without immediately triggering multiple signaling flows for a change in context ownership. The proposed solution is backwards compatible and works for all model architectures defined by 3gpp (e.g., if no custom AVP is included, the NFs may still function according to a default standard or an operator-specific configuration). The proposed solution not only helps in N7 and Rx flows, but in 4G PCRF (Policy and Charging Rules Function) for Gx and Rx messaging as well. Thus, the solution benefits multi-site active/active deployments of PCF as well as PCRF. An example process of implementing intermittent failure handling for network functions is described in regard to FIG. 3.

FIG. 3 is a flow diagram of a system 300 configured to implement intermittent failure handling for network functions, in accordance with certain embodiments of the present disclosure. In particular, the diagram may depict a process flow within a wireless or cellular communication network by which sessions are created between consumer NF and producer NF, and messaging is rerouted based on communication or connection failures between NF. System 300 may include an AF 312, a BSF or DRA 310, an SMF 306, a PCF1308, and a PCF2309. In the example of system 300, there may be a communication failure between BSF 310 and PCF1308, wherein PCF1 is determined to be ‘unreachable’, so that the Rx messaging is rerouted by BSF 310 to PCF2309. The components in diagram 300 may correspond to elements described in regard to FIG. 1.

At 320, PCF1308 and PCF2309, which may be part of a PCF set with each other, may establish a process of performing periodic health checks to determine a health status of each other (and any other PCFs within the PCF set). Health details may be obtained based on health information subscriptions that each PCF establishes with an NRF (not shown), based on vendor-specific or custom health check procedures between the PCFs themselves, or based on other health check procedures. Health check information may be obtained on a periodic or intermittent basis, in response to specific triggers, or at other intervals. Each PCF may store a most recent health status update for the other PCFs in the set, to access as needed when determining how to handle rerouted messages and sessions.

At 322, SMF 306 and PCF1308 may establish an N7protocol messaging session, for example via an SM (session management) creation request. The N7 session may be created based on a PDU session established when a user equipment (UE) connects with a network. Based on the created N7 session, SMF 306 may send any N7 messages to PCF1 308 for the relevant PDU session. In response to N7 session creation, PCF1 308 may register a binding record with BSF 310 for the PDU session, at 324. Based on the binding record, the BSF 310 may route Rx protocol messages related to the PDU session to PCF1308.

At 326, an AF 312 may send an Rx protocol AAR (authorization authentication request) message related to the PDU session to BSF 310 for routing to the relevant PCF. An AAR message may be a Diameter message used in the PCC (Policy and Charging Control) framework, which allows an AF to supply session related information to the PCF (or PCRF) managing the PDU session. The BSF 310 may perform a binding record lookup to determine the target PCF, and may determine that the target is PCF1308. At 328, The BSF 310 may then send a SYN synchronization message to attempt to establish a connection with PCF1308. In an alternate embodiment, the BSF 310 may forward the Rx message and an indication of the identified target PCF and any associated PCF set data to a diameter routing agent (DRA) 310, which may perform Diameter message routing or rerouting.

At 330, the BSF/DRA 310 may determine that PCF1308 is unreachable, for example due to never receiving a SYN acknowledgement response from PCF1308. In response, at 332, the BSF/DRA 310 may reroute the Rx-AAR message to an alternate PCF in a same PCF set with PCF1 308; in the depicted example, to PCF2 309. The BSF/DRA 310 may include an AVP of “Reroute cause: unreachable” in the rerouted message.

PCF2309 may receive the rerouted Rx-AAR message and the “unreachable” AVP, which message may also identify PCF1 308 as the original intended target. At 334, PCF2 309 may determine a health status of PCF1308, based on the periodic health check information 320. The health status information may provide information on whether PCF1308 has recently responded to health checks or pings, and may indicate whether PCF1308 is suffering from an intermittent problem or a persistent problem. For example, the health checks may indicate whether a communication failure may have only occurred between BSF 310 and PCF1308, or is affecting PCF1308 in general. Based on the health status information, the PCF2309 may determine that PCF1308 is healthy, and that the connection failure is likely intermittent. At 336, PCF2308 may process the rerouted Rx – AAR request on behalf of PCF1. At 338, PCF2308 may send an UpdateNotify request to SMF 306 regarding the N7 session, with the request not including updated binding information. SMF 306 may provide a 2xx response code acknowledging the UpdateNotify, at 340, and may maintain PCF1308 as the appropriate PCF for the N7 session. PCF2309 may prepare and send an Rx - AAA (application authentication answer) message to BSF/DRA 310 in response to the Rx-AAR message, at 342. The PCF2309 may prepare the Rx-AAA message with an “origin-host” value of PCF1308, so that future Rx messages are directed to the original target of PCF1. BSF 310 may receive and forward the Rx – AAA message to AF 312, at 344. Accordingly, subsequent Rx flows from AF 312 for the PDU session may be sent to PCF1 308, at 346, and subsequent N7 flows may be sent from SMF 306 to PCF1308, at 348.

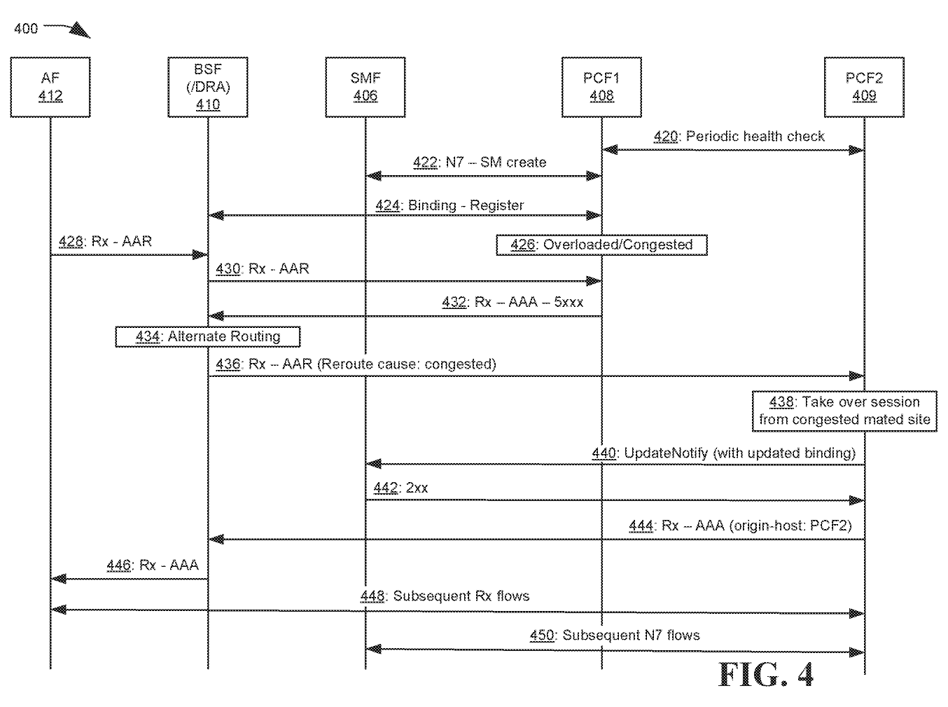

In an alternative example, after receiving the rerouted Rx-AAR message at 332, the PCF2309 may determine that PCF1308 is not healthy, at 334. In this case, PCF2309 may send an UpdateNotify message to SMF 306 with updated binding information identifying PCF2309, at 338. This may cause SMF 306 to update the PCF associated with the PDU session to PCF2. Similarly, the Rx-AAA response sent by PCF2309 at 342 may identify the origin-host as PCF2, which response may be forwarded by BSF 310 to AF 312, at 344. The AF 312 (or a P-CSCF, Proxy Call Session Control Function) may note the origin-host identified in the Rx-AAA response. Based on the updated origin-host, the AF 312 or P-CSCF can provide the updated destination host in AAR-U (update) requests toward BSF 310 for that same Rx session, and therefore the BSF 310 may route the update requests without performing a binding lookup. For a single N7 session, Rx sessions may be setup and terminated multiple times, so AAR-I requests may occur repeatedly. The BSF 310 may only perform binding lookup for an AAR-I (initial) request when a new Rx session is established, so that subsequent requests are routed according to the host identified in AAR-U requests. On a next AAR-I (for a new Rx session), the BSF 310 may perform another binding lookup to perform routing, and may use the original PCF1 308 if the binding record is never updated. Accordingly, subsequent N7 and Rx (for a same Rx session) flows may be directed to PCF2 309, at 346 and 348. Another example process of implementing intermittent failure handling for network functions is described in regard to FIG. 4.

FIG. 4 is a flow diagram of a system 400 configured to implement intermittent failure handling for network functions, in accordance with certain embodiments of the present disclosure. In particular, the diagram may depict a process flow within a wireless or cellular communication network by which sessions are created between consumer NF and producer NF, and messaging is rerouted based on communication or connection failures between NF. System 400 may include an AF 412, a BSF or DRA 410, an SMF 406, a PCF1408, and a PCF2409. In the example of system 400, there may be a communication failure between BSF 410 and PCF1408, wherein the failure may be based PCF1 being congested, so that the Rx messaging is rerouted by BSF 410 to PCF2409. The components in diagram 400 may correspond to elements described in regard to FIG. 1.

At 420, PCF1 408 and PCF2409 may establish a process of performing periodic health checks to determine a health status of each other (and any other PCFs within the PCF set), as described in regard to FIG. 3. At 422, SMF 406 and PCF1 408 may establish an N7 protocol messaging session for a UE connection, for example via an SM creation request. Based on the created N7 session, SMF 406 may send any N7 messages to PCF1408 for the relevant PDU session. In response to N7 session creation, PCF1408 may register a binding record with BSF 410 for the PDU session, at 424. Based on the binding record, the BSF 310 may route Rx protocol messages related to the PDU session to PCF1 408.

At 426, PCF1408 may become congested or overloaded, for example due to handling too many incoming requests or sessions. At 428, an AF 412 may send an Rx protocol AAR message related to the IMS (IP multimedia subsystem) or PDU session to BSF 410 for routing to the relevant PCF. The BSF 410 may perform a binding record lookup to determine the target PCF, and may determine that the target is PCF1408. The BSF 410 may establish a connection with PCF1 408 and route the Rx-AAR request to PCF1, at 430. In an alternate embodiment, the BSF 410 may forward the Rx message and an indication of the identified target PCF and any associated PCF set data to a diameter routing agent (DRA) 410, which may perform Diameter message routing or rerouting. Due to the congested status, PCF1 408 may return an Rx-AAA response indicating that PCF1 is congested, such as via a 5xxx server error Diameter result code.

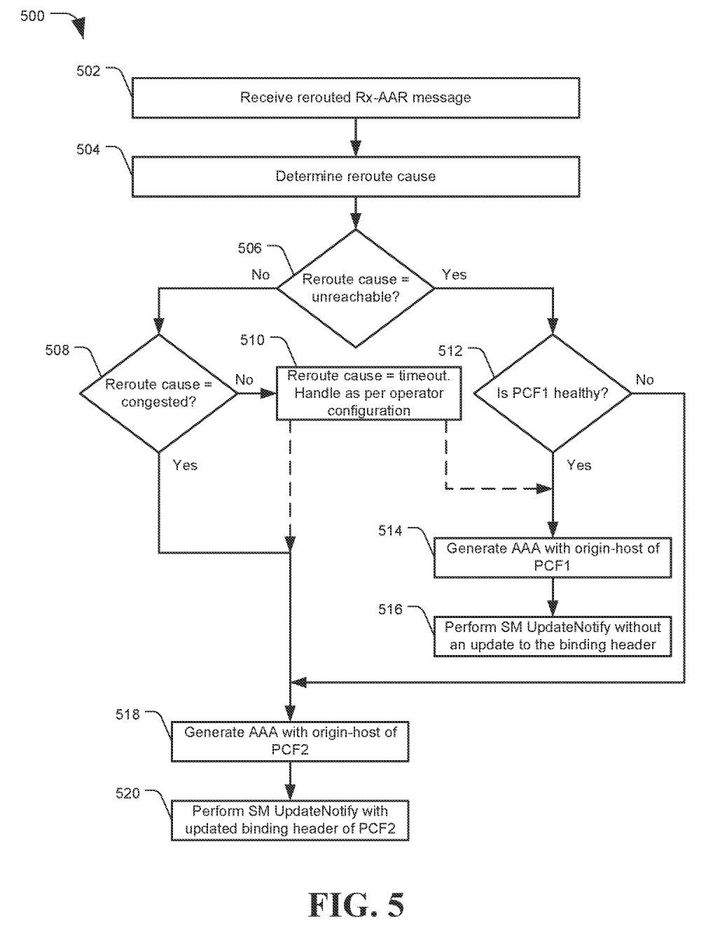

In response to PCF1’s 408 congested status, the BSF/DRA 410 may determine alternate routing options, for example based on other PCFs in a PCF set with PCF1, at 434. BSF/DRA 410 may route the Rx-AAR request, along with an indication that the reroute cause was a congested status, to PCF2409, at 436. At 438, based on the reroute cause, PCF2409 may take over the session(s) from the congested mated instance of PCF1408, rather than merely handling the instant Rx-AAR request on behalf of PCF1. At 440, PCF2409 may send an UpdateNotify request to SMF 406 regarding the N7 session, with the request including updated binding information identifying PCF2. SMF 406 may provide a 2xx response code acknowledging the UpdateNotify, at 442, and may change the appropriate PCF for the N7 session from PCF1 408 to PCF2409. PCF2409 may prepare and send an Rx - AAA message to BSF/DRA 410 in response to the Rx-AAR message, at 444. The PCF2409 may prepare the Rx-AAA message with an “origin-host” value of PCF1409, so that future Rx messages are directed to the new target of PCF2. BSF 410 may receive and forward the Rx – AAA message to AF 412, at 446. Subsequent Rx flows from AF 412 for the PDU session may be sent to PCF2 409, at 448, and subsequent N7flows may be sent from SMF 406 to PCF2409, at 450. An example flowchart describing a process for intermittent failure handling for network functions is described in regard to FIG. 5.

FIG. 5 depicts a flowchart 500 of an example method to implement intermittent failure handling for network functions, in accordance with certain embodiments of the present disclosure. In particular, flowchart 500 depicts an example process by which a target NF of a rerouted session message may determine the reroute cause, and adjust its behavior based on the cause to minimize network disruption. The method of flowchart 500 may be executed by an NF within a network, such as PCF1108, PCF2109, SMF 106, or BSF 110 of network 104 of FIG. 1.

At 502, the method may include receiving a rerouted session message, such as an Rx-AAR Diameter protocol request message rerouted by a BSF to an alternate PCF (e.g., PCF2). The message may be regarding an NF-to-NF session related to a UE communication session. At 504, the method may include determining the cause for the rerouting of the message. The reroute cause may be included with the request message as a custom attribute-value pair (AVP) or other custom parameter. In the depicted example method, the cause may include “unreachable, “congested”, or “timeout”, although other causes may be included in other embodiments.

At 506, a determination may be made whether the reroute cause is “unreachable”. If yes, the method may include determining whether the original target NF (e.g., PCF1 in this example) is healthy, at 512. A health status of an NF may be determined in various ways, such as subscribing to health notifications for the NF with an NF repository function (NRF), querying the NRF for the health status, or obtaining health details from the target NF in question. Health status for a given NF, such as NFs in a same set as the NF performing the method of FIG. 5, may be obtained periodically or at selected intervals, rather than in response to the rerouted request. The health status may indicate whether the target NF has crashed or experienced network loss, or is still functioning and reachable from at least some other NFs. If PCF1 is health, at 512, the method may include generating an Rx-AAA response with the origin-host set to PCF1, at 514, and potentially performing an SM UpdateNotify operation without an update to the binding header for a related N7 protocol session, at 516. This may result in NF sessions related to the PDU session remaining with PCF1, rather than being transferred to PCF2.

If PCF1 is not health, at 512, the method may include generating an Rx-AAA response with the origin-host set to PCF2, at 518, and performing an SM UpdateNotify operation with an updated binding header identifying PCF2, at 520. This may result in NF sessions related to the PDU session being transferred to PCF2, rather than remaining with PCF1.

If the reroute cause is not “unreachable”, at 506, the method may include determining whether the reroute cause is “congested”, at 508. If yes, the method may include generating an Rx-AAA response with the origin-host set to PCF2, at 518, and performing an SM UpdateNotify operation with an updated binding header identifying PCF2, at 520, as described above.

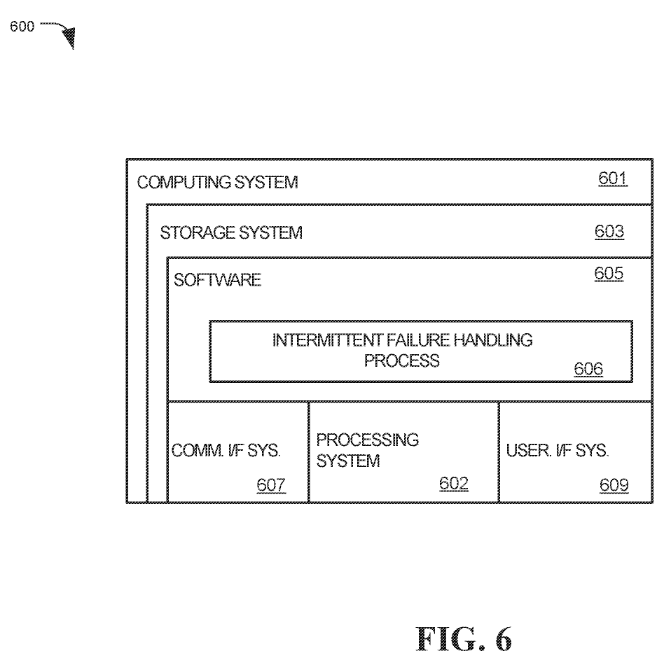

If the reroute cause is not “congested”, at 508, the method may include determining that the reroute cause is “timeout”, at 510. A reroute cause of “timeout” may be handled according to an operator configuration, and may be handled by either keeping the NF sessions with the original target of PCF1, or transferring the sessions to PCF2. If the operator settings dictate keeping the sessions with PCF1, the method may include generating an Rx-AAA response with the origin-host set to PCF1, at 514, and potentially performing an SM UpdateNotify operation without an update to the binding header for a related N7 protocol session, at 516, as described above. If the operator settings dictate transferring the sessions to PCF2, the method may include generating an Rx-AAA response with the origin-host set to PCF2, at 518, and performing an SM UpdateNotify operation with an updated binding header identifying PCF2, at 520, as described above. A computing system configured to perform the operations and methods described herein is provided in regard to FIG. 6.

FIG. 6 is a diagram of a system 600 configured to implement intermittent failure handling for network functions, in accordance with certain embodiments of the present disclosure. System 600 may be an example of an apparatus including a computing system 601 that is representative of any system or collection of systems in which the various processes, systems, programs, services, and scenarios disclosed herein may be implemented. For example, computing system 601 may be an example user equipment 102, network connectivity components 120, network 104, SMF 106, PCF 108, BSF 110, AF 112, IFM 114, or any of the subcomponents depicted or described in system 100 of FIG. 1. Examples of computing system 601 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 may include, but is not limited to, processing system 602, storage system 603, software 605, communication interface system 607, and user interface system 609. Processing system 602 may be operatively coupled with storage system 603, communication interface system 607, and user interface system 609.

Processing system 602 may load and execute software 605 from storage system 603. Software 605 may include and implement intermittent failure handling process 606, which may be representative of any of the operations for detecting a connection failure between NFs in a session, rerouting a request with a reroute cause indicator, and processing a rerouted message in a variety of ways based on the reroute cause indication, as discussed with respect to the preceding figures. When executed by processing system 602, software 605 may direct processing system 602 to operate as described herein for at least the various processes, operational scenarios, and sequences discussed in the foregoing implementations. Computing system 601 may optionally include additional devices, features, or functionality not discussed for purposes of brevity.

In some embodiments, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 may include general purpose central processing units, graphical processing units, application specific processors, and logic devices, as well as any other type of processing device, combinations, or variations thereof.

Storage system 603 may comprise any memory device or computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including intermittent failure handling process 606 among other functions) may be implemented in program instructions that may, when executed by processing system 602, direct processing system 602 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable storage medium(s) having computer readable program code embodied thereon.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all the following interpretations of the word: any of the items in the list, all the items in the list, and any combination of the items in the list.

The phrases "in some embodiments," "according to some embodiments," "in the embodiments shown," "in other embodiments," and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for” but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A Network Function (NF) system in a network, comprising:
one or more processors; and
a memory having stored thereon instructions that, upon execution by the one or more processors, cause the one or more processors to:
receive, at an alternate NF, a rerouted request originally directed to a target NF in a messaging session between NFs, the rerouted request including an indication of a reason the rerouted request was rerouted;
determine, at the alternate NF based on the reason, whether to take over the messaging session from the target NF; and
process the rerouted request based on the determination of whether to take over the messaging session.

2. The NF system of claim 1, wherein the rerouted request utilizes a Diameter protocol.

3. The NF system of claim 2, wherein the network includes a fifth generation (5G) cellular network.

4. The NF system of claim 1, wherein:
the messaging session includes an Rx interface protocol session; and
the rerouted request includes an Rx message routed by a binding support function (BSF) to the alternate NF.

5. The NF system of claim 4, wherein the instructions comprise further instructions that, upon execution by the one or more processors, cause the one or more processors to:
determine, at the alternate NF based on the reason, whether to take over both the messaging session and a second messaging session between NFs.

6. The NF system of claim 5, wherein:
the second messaging session includes a Gx interface messaging session, using a Diameter protocol, between policy and charging enforcement function (PCEF) and the target NF; and
the target NF and the alternate NF each include a policy and charging rules function (PCRF) instance.

7. The NF system of claim 5, wherein:
the second messaging session includes an N7 interface messaging session, using a service-based interface (SBI) protocol, between a session management function (SMF) and the target NF; and
the target NF and the alternate NF each include a policy control function (PCF) instance, wherein the target NF and the alternate NF are both members of an NF set of NFs configured to replicate context data between the members and operate as alternates if an NF from the NF set fails.

8. The NF system of claim 7, wherein the instructions comprise further instructions that, upon execution by the one or more processors, cause the one or more processors to:
determine that the reason is that the target NF is congested, indicating that the target NF is overloaded with traffic, and
based on the reason,
take over the messaging session by generating a response to the rerouted request identifying an origin-host as the alternate NF; and
take over the second messaging session by performing a session management (SM) UpdateNotify operation including an updated binding header identifying the alternate NF.

9. The NF system of claim 8, wherein the instructions comprise further instructions that, upon execution by the one or more processors, cause the one or more processors to:
determine that the reason is that the target NF is unreachable, indicating that a communication connection could not be established with the target NF; and
based on the reason, determine a health status of the target NF, with an unhealthy health status indicating that the target NF is unavailable, and a healthy health status indicating that the target NF is available.

10. The NF system of claim 9, wherein the instructions comprise further instructions that, upon execution by the one or more processors, cause the one or more processors to:
based on the target NF having a healthy health status, determine to not take over the messaging session, including:
generate a response to the rerouted request identifying an origin-host as the target NF; and
not take over the second messaging session, including performing a session management (SM) UpdateNotify operation without an updated binding header;
based on the target NF having an unhealthy health status, determine to take over the messaging session, including:
generate a response to the rerouted request identifying the origin-host as the alternate NF; and
take over the second messaging session by performing a session management (SM) UpdateNotify operation including an updated binding header identifying the alternate NF.

11. A method comprising:
operating a Network Function (NF) of a network, including:
receiving, at an alternate NF, a rerouted request originally directed to a target NF in a messaging session between NFs, the rerouted request including an indication of a reason the rerouted request was rerouted;
determining, at the alternate NF based on the reason, whether to take over the messaging session from the target NF; and
processing the rerouted request based on the determination of whether to take over the messaging session.

12. The method of claim 11, wherein the rerouted request utilizes a Diameter protocol.

13. The method of claim 12, wherein the network includes a fifth generation (5G) cellular network.

14. The method of claim 11, wherein:
the messaging session includes an Rx interface protocol session; and
the rerouted request includes an Rx message routed by a binding support function (BSF) to the alternate NF.

15. The method of claim 14, further comprising
determining, at the alternate NF based on the reason, whether to take over both the messaging session and a second messaging session between NFs.

16. The method of claim 15, wherein:
the second messaging session includes a Gx interface messaging session, using a Diameter protocol, between policy and charging enforcement function (PCEF) and the target NF; and
the target NF and the alternate NF each include a policy and charging rules function (PCRF) instance.

17. The method of claim 15, wherein:
the second messaging session includes an N7 interface messaging session, using a service-based interface (SBI) protocol, between a session management function (SMF) and the target NF; and
the target NF and the alternate NF each include a policy control function (PCF) instance, wherein the target NF and the alternate NF are both members of an NF set of NFs configured to replicate context data between the members and operate as alternates if an NF from the NF set fails.

18. The method of claim 15, further comprising:
determining that the reason is that the target NF is congested, indicating that the target NF is overloaded with traffic, and
based on the reason,
taking over the messaging session by generating a response to the rerouted request identifying an origin-host as the alternate NF; and
taking over the second messaging session by performing a session management (SM) UpdateNotify operation including an updated binding header identifying the alternate NF.

19. The method of claim 15, further comprising:
determining that the reason is that the target NF is unreachable, indicating that a communication connection could not be established with the target NF; and
based on the reason, determining a health status of the target NF, with an unhealthy health status indicating that the target NF is unavailable, and a healthy health status indicating that the target NF is available.

20. The method of claim 19, further comprising:
based on the target NF having a healthy health status, determine to not take over the messaging session, including:
generating a response to the rerouted request identifying an origin-host as the target NF; and
not taking over the second messaging session, including performing a session management (SM) UpdateNotify operation without an updated binding header;
based on the target NF having an unhealthy health status, determine to take over the messaging session, including:
generating a response to the rerouted request identifying the origin-host as the alternate NF; and
taking over the second messaging session by performing a session management (SM) UpdateNotify operation including an updated binding header identifying the alternate NF.
